(19) United States
(12) Patent Application Publication
(10) Pub. No.: US 2014/0201681 A1
(43) Pub. Date: Jul. 17, 2014

(54) METHOD AND SYSTEM FOR MANAGING AND DISPLAYING ACTIVITY ICONS ON A MOBILE DEVICE

(71) Applicant: LOOKOUT, INC., San Francisco, CA (US)

(72) Inventors: Kevin Patrick Mahaffey, San Francisco, CA (US); Brian James Buck, Livermore, CA (US)

(73) Assignee: LOOKOUT, INC., SAN FRANCISCO, CA (US)

(21) Appl. No.: 13/742,933

(22) Filed: Jan. 16, 2013

(51) Int. Cl. G06F 3/0481

(52) U.S. Cl. CPC G06F 3/04817
USPC 715/846

(57) ABSTRACT

Embodiments are directed to managing applications and displaying icons on a mobile device through processes that monitor usage of the applications by a user, alter a display of an application icon based on the usage of the application and a context of the mobile device, and suggest substitute or additional applications for installation based on the usage of the application. The context may comprise a location of the device, a time and/or frequency of usage of an application, and an activity associated with the usage of the application. The icon may be minimized or eliminated from display if the usage falls below a defined threshold for a context, or it may be maximized if the usage exceeds the defined threshold for the context.

### TECHNICAL FIELD

One or more embodiments relate generally to mobile electronic devices and more specifically to systems and methods for displaying icons and managing application on mobile devices.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Mobile electronic communication devices have evolved beyond simple telephone functionality and are now highly complex multifunctional devices with capabilities approaching desktop or laptop computers. In addition to voice communications, many mobile communication devices are capable of text messaging, e-mail communications, Internet access, and running full-featured application software. Smartphones and similar advanced mobile devices typically run a mobile operating system (e.g., Android, iOS, etc) to manage communication functions and execute applications (‘apps’) that are installed on the device. As the power of these devices increases, so too does the number of apps that can be installed and run to the point that smartphones and tablet computers are rapidly becoming the principal computing device for many people. Greater reliance on mobile devices has consequently placed a great deal of emphasis on the display and graphical user interface (GUI) aspects of these devices, as touchscreen displays have increasingly come to replace the familiar numeric or QWERTY keyboard as the primary interface. A universal constraint facing smartphones and smaller tablet computers, however, is the physical limitation of the display size. No matter how powerful or sophisticated a smartphone or other mobile device may become, it is practically limited to a relatively small display size due to the need to keep it hand-held and portable.

In the face of the display size constraint, the ever-increasing number of applications available for installation on mobile devices has necessitated the need to manage the graphical presentation and management of all of the visual elements that can be displayed through the display. Applications and other device functions are typically represented as icons on the display screen, and a typical user may have dozens of applications that he or she uses on a regular or semi-regular basis. However, since the display area on a mobile device is typically limited to 3-5 inches, a large number of icons can quickly clutter a screen or require scrolling or switching of screens to view all of the available icons. This can limit the usability of the interface and cause a great deal of user frustration.

Although certain user interface methods are presently available to help users organize or simplify their device home screens, these methods typically require a great deal of manual input by the user to create folders or containers and move icons around in a desired organizational structure. Other systems may allow for the automatic selection of home screens that have been pre-configured by the user. However, these systems also generally require a high degree of user input or configuration, and do not provide full automation of tasks associated with displaying and organizing application icons for efficient display and effective interface strategies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 is a block diagram illustrating an example system including mobile devices and other computers coupled to a network according to an embodiment;

FIG. 2 a block diagram illustrating an example system for managing applications on an mobile device according to an embodiment;

FIG. 3 is a flow diagram illustrating a method of managing applications and activities on a mobile device according to an embodiment;

FIG. 4 is a flowchart that illustrates a method of modifying the appearance of icons based on usage and context, under an embodiment.

FIG. 5 illustrates the enhancement of displayed icons through certain visual features, under an embodiment.

FIG. 6 illustrates an example of different icon visibility based on different context regions, under an embodiment.

FIG. 7 illustrates the modification of displayed icons using icon grouping structures, under an embodiment.

FIG. 8 is a detailed illustration of icons displayed within an application folder of FIG. 7, under an embodiment.

FIG. 9 illustrates a method of providing suggestions/substitute apps to a user, under an embodiment.

FIG. 10 illustrates a potential desired position conflict that is resolved by an application management process, under an embodiment.

FIG. 11 illustrates a resulting display arrangement resolving the position conflict of FIG. 10, under an embodiment.

FIG. 12 illustrates the use of folders to resolve the desired position conflict, under an embodiment.

FIG. 13 illustrates the use of altered spacing to resolve an icon display conflict, under an embodiment.

FIG. 14 illustrates an example display of icons across multiple windows for different context regions under a first embodiment.

FIG. 15 illustrates an example display of icons across multiple windows for different context regions under a second embodiment.

### INCORPORATION BY REFERENCE

Each publication, patent, and/or patent application mentioned in this specification is herein incorporated by reference in its entirety to the same extent as if each individual publication and/or patent application was specifically and individually indicated to be incorporated by reference.

### DETAILED DESCRIPTION

It should be appreciated that the present invention can be implemented in numerous ways, including as a process, an apparatus, a system, a device, a method, or a computer readable medium such as a computer readable storage medium containing computer readable instructions or computer program code, or a computer network wherein computer readable instructions or computer program code are sent over optical or electronic communication links. Applications, software programs or computer readable instructions may be referred to as components, modules, or processes. Applications may take the form of software executing on a general purpose computer or be hardwired or hard coded in hardware. Applications may also be downloaded in whole or in part through the use of a software development kit, framework, or toolkit that enables the creation and implementation of the present invention. In this specification, these implementations, or any other form that the invention may take, may be referred to as techniques. In general, the order of the steps of disclosed processes may be altered within the scope of the invention.

Systems and methods are provided for optimizing the display of icons and managing and updating applications on a mobile device. In particular, embodiments are directed to systems and methods that automatically alter the display of icons associated with applications or activities to enhance the visibility (maximize), decrease the visibility (minimize), or hide icons based on several contextual factors including application usage by the user or other users, location, time, activities, and other similar factors. Further embodiments are directed to providing suggestions or notifications to the user of possibly desirable applications to add to the device or substitute for other applications based on these contextual factors.

In the description that follows, the subject matter will be described with reference to acts and symbolic representations of operations that are performed by one or more devices, unless indicated otherwise. As such, it will be understood that such acts and operations, which are at times referred to as being computer-executed, include the manipulation by the processing unit of data in a structured form. This manipulation transforms the data or maintains it at locations in the memory system of the device, which reconfigures or otherwise alters the operation of the device in a manner well understood by those skilled in the art. The data structures where data is maintained are physical locations of the memory that have particular properties defined by the format of the data. However, while the subject matter is being described in the foregoing context, it is not meant to be limiting as those of skill in the art will appreciate that various of the acts and operation described hereinafter may also be implemented in hardware.

As used herein, the term “mobile device” refers to electronic communication and processing devices that are portable and relatively small, such as mobile phones, tablet computers, Personal Digital Assistants (PDAs), smartphones, and the like. This term also refers to a class of laptop computers, notebook, or netbook computers that run an operating system that is also used on mobile phones, tablets, PDAs, or smartphones, and so on. Such devices are often designed to operate with a continuous connection to a cellular network or to the Internet via a wireless link. Specifically, mobile devices include devices for which wireless communication services such as voice, messaging, data, or other wireless Internet capabilities are a primary function. As used herein, a “mobile device” may also be referred to as an “electronic client device,” “mobile communication device,” “mobile client,” or “handset.” However, a person having skill in the art will appreciate that while the present invention is disclosed herein as being used on mobile communication devices, the present invention may also be used on other computing platforms, including desktop, laptop, notebook, netbook, or server computers.

As used herein, the term “client computer” refers to any computer, embedded device, mobile device, or other system that can be used to perform the functionality described as being performed by the client computer. Specifically, client computers include devices that can be used to display a user interface by which the functionality provided by a server can be utilized by a user. Client computers may be able to display a web page, load an application, load a widget, or perform other display functionality that allows the client computer to report information from the server to the user and to receive input from the user in order to send requests to the server.

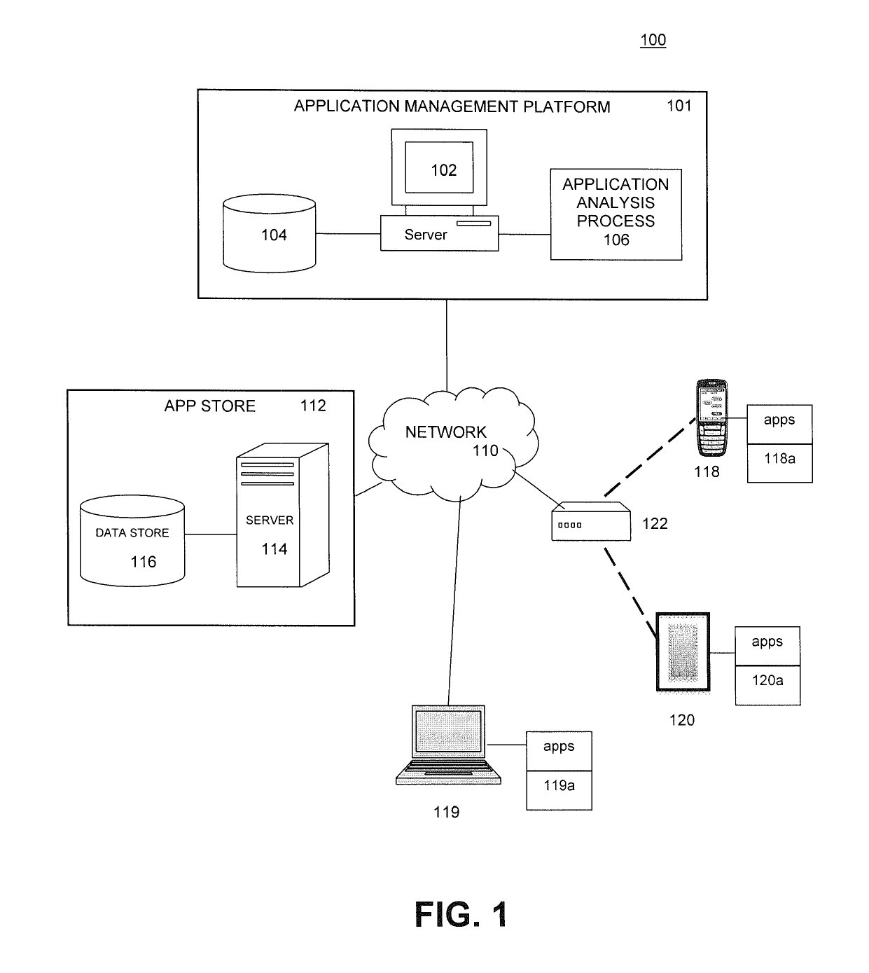

Aspects of the one or more embodiments described herein may be implemented on one or more computers executing software instructions. The computers may be networked in a client-server arrangement or similar distributed computer network. FIG. 1 illustrates a computer network system 100 that supports mobile communication devices and other network elements to implement one or more embodiments. Those of ordinary skill in the art will appreciate that the elements illustrated in FIG. 1 may vary depending on the system implementation. In system 100, a network server computer 102 is coupled, directly or indirectly, to one or more network client computers and devices through a network 110. The network interface between the server and client devices may include one or more routers that serve to buffer and route the data transmitted between the server and client computers. Network 110 may be the Internet, a Wide Area Network (WAN), a Local Area Network (LAN), or any combination thereof.

In one embodiment, one or more of the server computers 102 may be a World-Wide Web (WWW) server that stores data in the form of web pages and transmits these pages as Hypertext Markup Language (HTML) files over the Internet 110 to one or more client computers. For this embodiment, the client computer typically runs a web browser program to access the web pages served by a server computer (e.g., server 102) and any available content provider or supplemental server (e.g., server 114). For the embodiment illustrated in diagram 100, the client devices are mobile devices, such as a mobile phone 118, smartphone 120, and tablet or laptop computer 119. At least some of these devices (e.g., phones 118 and 120) may be wireless devices that access network 110 through wireless hubs 122 or service provider equipment, such as cell sites or other wireless communication routers.

Each of the client devices 118-120 is a processor-based device that executes an operating system (e.g., Android, iOS, etc.) and is capable of executing applications to perform any appropriate task associated with the operation and function of the device. Applications executed by mobile devices may be provided as part of the native mobile operating system or they may separate programs that can be purchased or obtained from third party vendors for downloading to the mobile device. Server 114 represents a system maintained by a third party that provides applications stored through an app store 112 to users of devices in system 100. App store 112 typically comprises at least one server 114 and associated data store(s) 116 that store the applications to be downloaded by the client devices 118-120, and can represent any type of server system that provides applications to users on network 110.

In an embodiment, each mobile device 118-120 executes an application management component 118a-120a that manages applications loaded onto the device and coordinates with the GUI of the device to display icons and other information associated with each application through the device display. The application management component uses information regarding the device (display size/resolution, processing power, GUI capabilities, etc.), the applications (type, importance, etc.), as well as contextual information regarding usage of the device (e.g., location, communication means, times of use, etc.) and the applications (e.g., usage frequency, duration, etc.) to determine how best to display the icons for each application, as well as automatically suggest or substitute potentially useful new applications for download to the device.

In the same or another embodiment, an application management platform 101 comprising server 102 may execute a server-side application analysis process 106. The application analysis process may be configured to monitor the applications and activities executed or performed by the mobile devices, as well as their usage contexts. Usage by any number of networked users may be monitored to compile a database 104 of usage data. Using this information, process 106 can manage the display of icons on the appropriate mobile devices 118-120 and cause the suggestion or substitution of appropriate applications on these devices. The server-side process 106 may be run in conjunction with or instead of the client-side versions 118a-120a. Any of the processes 106 and 118a-120a may represent one or more executable programs modules that are stored within their respective devices and executed locally within the device. Alternatively, however, they may be stored on a remote storage or processing device coupled to network 110 and accessed by the device to be locally executed.

As shown in diagram 100, a mobile device (e.g., 118 or 120) may operate in a networked environment using logical connections to one or more remote nodes 122 via a communication interface. The remote node may be another computer, a server, a router, a peer device or other common network node, and typically includes many or all of the elements described above relative to the mobile device. The communication interface may interface with a wireless network and/or a wired network. Examples of wireless networks include, for example, a Bluetooth network, a wireless personal area network, a wireless 802.11 local area network (LAN), and/or wireless telephony network (e.g., a cellular, PCS, or GSM network). Examples of wired networks include, for example, a LAN, a fiber optic network, a wired personal area network, a telephony network, and/or a wide area network (WAN). Such networking environments are commonplace in intranets, the Internet, offices, enterprise-wide computer networks and the like.

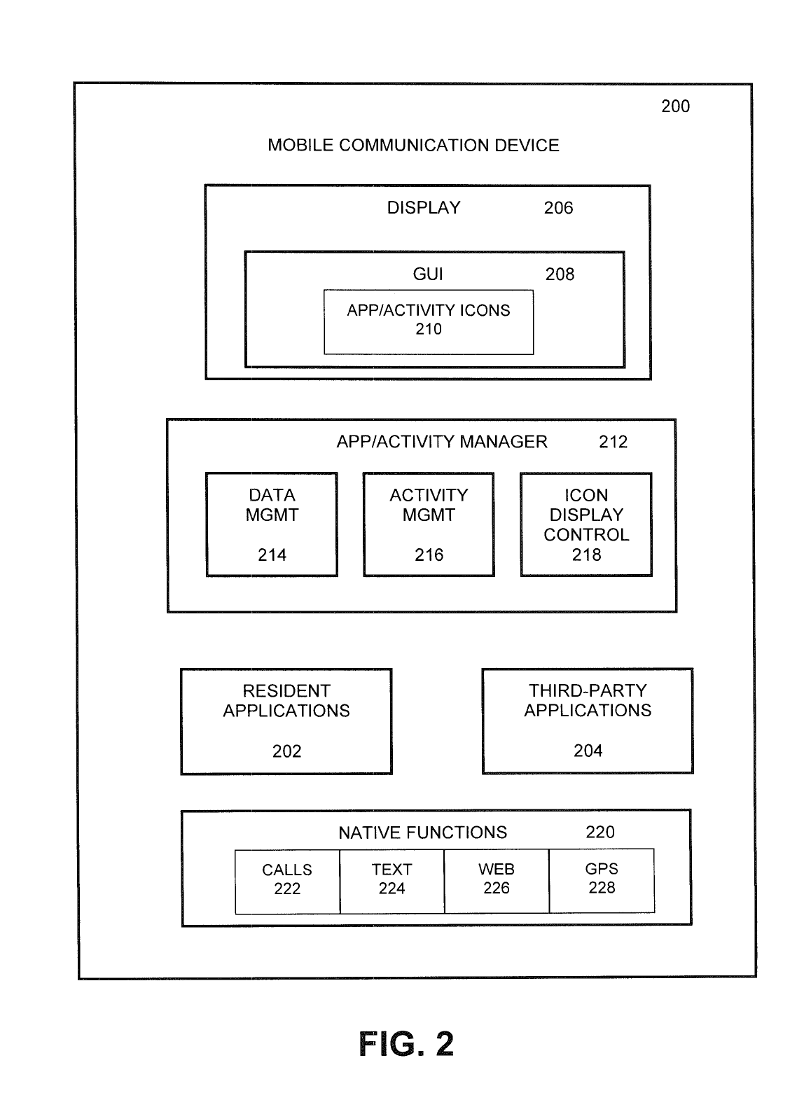

As shown in FIG. 1, network 100 includes one or more mobile devices that execute applications and implement at least some components of task management and icon display processes for these applications. FIG. 2 is a block diagram of an example system having components, and/or their analogs, that are configured to implement the icon and application management process according to an embodiment. As is shown in FIG. 2, the system can include an arrangement of components configured for managing various tasks associated with the functionality of the mobile device 200. FIG. 2 thus illustrates an example electronic client device that provides an execution environment configured to support operation of the icon display and application management process 118a. The mobile device 200 includes applications executed through the operating system and that can be either or both resident applications 202 that are provided as part of the device, or downloaded or third-party applications 204 that may be obtained by a vendor, such as app store 112. The mobile device also has certain native functions 220 for communication and other capabilities, such as phone 222 and text/messaging 224, web browser functionality 226, and location functions 228, such as a Global Positioning System (GPS) sensor. As known in the art, the mobile device 200 may also include other components not shown, such as an operating system, a processor, memory, an input device, a radio frequency transceiver(s), and a battery or power supply, among other components. The device operating system runs on the processor and enables interaction between application programs and the mobile device hardware components. In an embodiment, the mobile device 200 receives data through an RF transceiver(s), which may be able to communicate via various networks, for example: Bluetooth, local area networks such as WiFi, and cellular networks such as GSM, CDMA or LTE.

As shown in FIG. 2, the applications 202, 204 that are installed on mobile device 200 may be represented by icons 210 that are shown on display 206 through a GUI component 208. In an embodiment, an application may represent a computer program that performs a certain task or, in a more general sense, it may represent an activity performed using the device. An icon is generally a small graphical element (e.g., a picture) that represents an associated application or activity. For purposes of this description, the term icon means a small graphical element that represents an activity, wherein an application is a type of activity, and may include sub-applications, tasks, data content, parameterized activity, or other similar elements. It should also be noted that the term application comprises a software component that comprises three core components of activities, services, and broadcast receiver that are activated through messages that may be referred to as ‘intents.’ Unless stated otherwise, the term ‘application’ or ‘app’ shall mean either an application or an activity. Mobile device 200 includes an app manager component 212. This component comprises certain functions associated with the data 214, activities 216, storage and execution of applications on the mobile device 200. This component also includes an icon display control process 218 that manages the appearance of icons 210 associated with each application through GUI 208.

In an embodiment, app manager 212 is a local software component and application program that is downloaded to the mobile device 200 and is installed so that it integrates with the operating system of the device. Much of the source code for the local software component can be re-used between various mobile device platforms by using a cross-platform software architecture. In such a system, the majority of software functionality can be implemented in a cross-platform core module. The cross-platform core can be universal allowing it to interface with various mobile device operating systems by using a platform-specific module and a platform abstraction module that both interact with the mobile device operating system, which is described in U.S. patent application Ser. No. 12/255,626, entitled “SYSTEM AND METHOD FOR A MOBILE CROSS-PLATFORM SOFTWARE SYSTEM” which is hereby incorporated by reference in its entirety. In another embodiment, the local software component 212 can be device, platform or operating system specific.

It should be understood that the arrangement of mobile device 200 illustrated in FIG. 1 is but one possible implementation and that other arrangements are possible. It should also be understood that the various system components (and means) defined by the claims, described below, and illustrated in the various block diagrams represent logical components that are configured to perform the functionality described herein. For example, one or more of these system components (and means) can be realized, in whole or in part, by at least some of the components illustrated in the arrangement of mobile device 200. In addition, while at least one of these components are implemented at least partially as an electronic hardware component, and therefore constitutes a machine, the other components may be implemented in software, hardware, or a combination of software and hardware. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function), such as those illustrated in FIG. 2. Other components may be implemented in software, hardware, or a combination of software and hardware. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

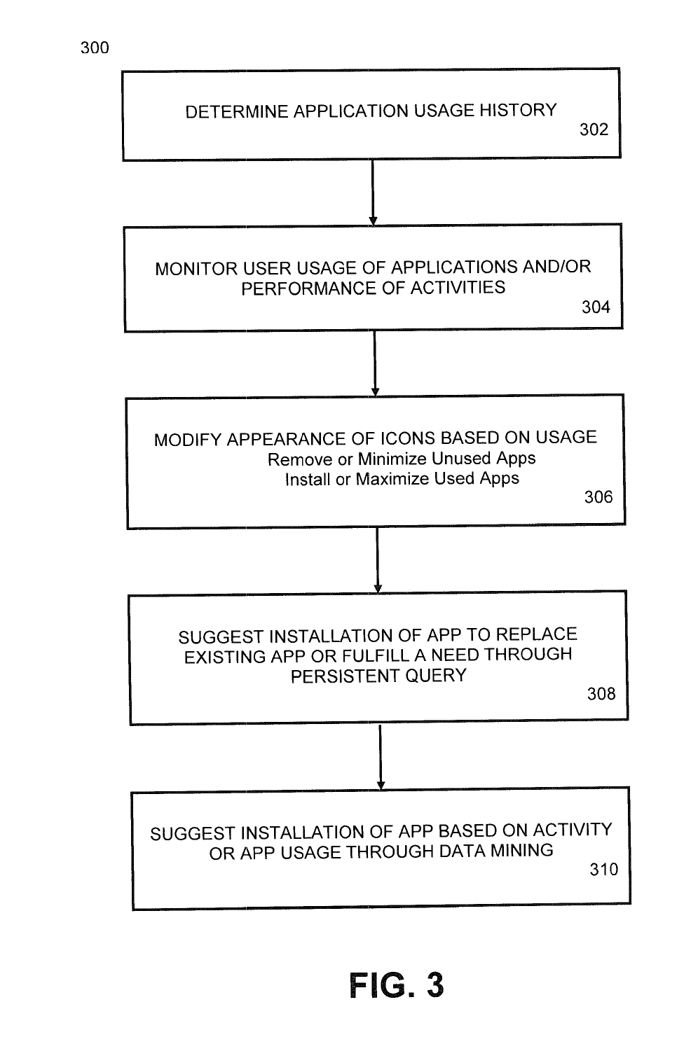

FIG. 3 is a flow diagram illustrating a method for managing applications and their respective icons on a mobile device according to an exemplary embodiment. The method illustrated in FIG. 3 can be carried out by, for example, at least some of the components in the example arrangement of components illustrated in FIG. 2, and specifically the app manager process 212. In an embodiment, the components illustrated in FIG. 2 can be configured to operate within an execution environment hosted by an electronic device and/or multiple electronic devices, as in a distributed execution environment, such as shown in FIG. 1. The main processes of method 300 include managing the visibility of icons on the device display and managing the availability of applications by suggesting or substituting applications on the device based on usage patterns and user and context (e.g., time, place, environment) characteristics. For purposes of the description, the functionality of the app manager component 212 and the associated methods or processes performed by this component may generally be referred to as ‘the system.’

Process 300 generally begins with a determination of application usage history on the mobile device, act 302. This establishes a baseline measure of usage, such as when a user first obtains a device or begins using the system and there is no prior application usage history available. Details regarding this initialization step are provided in the description that follows. Once a user starts using the mobile device, the system tracks or monitors the usage of applications loaded on the device, as well as any activities that are performed that may impact the display of one or more icons on the device, act 304. The usage information is then used by the system to modify the appearance of icons. This can include removing or minimizing icons associated with unused or unperformed activities, or installing or maximizing icons for well-used applications or activities. Since mobile device screens are small, and can only show a certain number of applications, the system displays certain icons to reflect an optimum presentation of most used apps. Some applications are used only at certain times or in certain places, and the system provides that only applications that are potentially relevant to time or place are displayed on the device screen to minimize clutter and optimize visual efficiency.

The system is also configured to manage applications by suggesting applications for download or substituting new or alternate applications for existing applications. For example, a user may know what they want to do via device function, but not have an app for it. In this case, the system can suggest an appropriate app that might be beneficial for the user. Likewise, a user may already have an app to perform a function, but it may not be the best app for a particular characteristic or requirement of the device or the usage context, such as location. For example, the Yelp application might work fine in San Francisco but there may be better apps or websites to suggest places to eat when the user is Beijing, Seoul, or Moscow. The system provides possible substitute apps to the user that help optimize device functionality, act 308. This suggestion process 308 may be performed through a persistent query operation. For example, the user might have a desire for an app to perform a particular function, but has been unable to find a desirable fit in the past. In this case, the system tracks the user's interest in a particular function or set of functions or category of app and continually checks for a good fit as new apps come out and suggests any appropriate new apps to the user. The suggestion process can also be performed through a data mining operation, act 310. In this case, there might be an app that would be useful to the user, but the user does not indicate any desire to access this potentially useful app. In an embodiment, the system is configured to mine for relevant usage, profile and context data to make suggestions of apps that might be helpful to the user, act 310.

### Icon Visibility

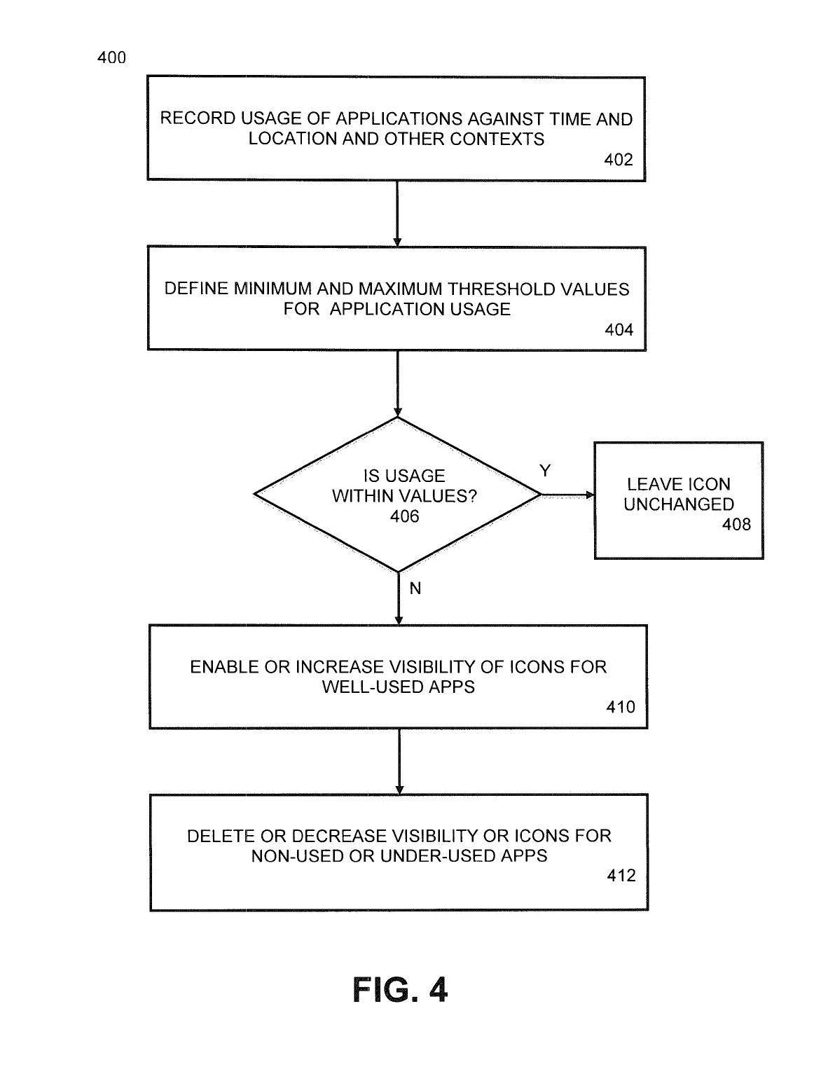

With respect to the icon visibility function, 306, the system tracks the usage and context of applications on the mobile device and modifies the appearance of the icons accordingly. FIG. 4 is a flowchart that illustrates a method of modifying the appearance of icons based on usage and context, under an embodiment. As shown in process 400, the system records the times and locations (and frequency) when apps have been used by a user, act 402. This allows the system to hide or enhance icon display based on relevant usage/context patterns. For example, apps that have never been used at a certain time-of-day (TOD) or day-of-week (DOW) or in a certain location (e.g., home or work) should not appear on the user's home screen at those times, days, or locations. The system records which apps are used when and where. The system keeps statistics on how frequently each app is used in time intervals and geographic regions, or in other semantic contexts that can be associated with or derived from geographic location, such as home or work, commuting or traveling, or weekday or weekend, or similar DOW/TOD times. These factors are referred to as ‘contextual regions’ or ‘context regions.’ A contextual region can be an hour range during the day, a specific location or a geographical proximity to a particular location, a day of the week, an environmental condition (e.g., average temperature, weather condition, etc.) or any other relevant data that provides information regarding usage of the device, or any combination of these characteristics. Actual location or geographical proximity to a particular location can be calculated by GPS components within the device or presence of a known beacon (such as the presence of a WiFi network with a particular name), triangulation, network location techniques, or other location determination methods.

The environmental conditions and resources that define the context or particular characteristics for a contextual region can be determined by various methods, such as that described in U.S. Provisional Patent Application No. 61/719,233, entitled “SYSTEM AND METHOD FOR DEVELOPING UPDATING AND USING USER AND DEVICE BEHAVIORAL CONTEXT MODELS TO MODIFY USER, DEVICE, AND APPLICATIONS STATE, SETTING AND BEHAVIOR,” which is hereby incorporated by reference in its entirety.

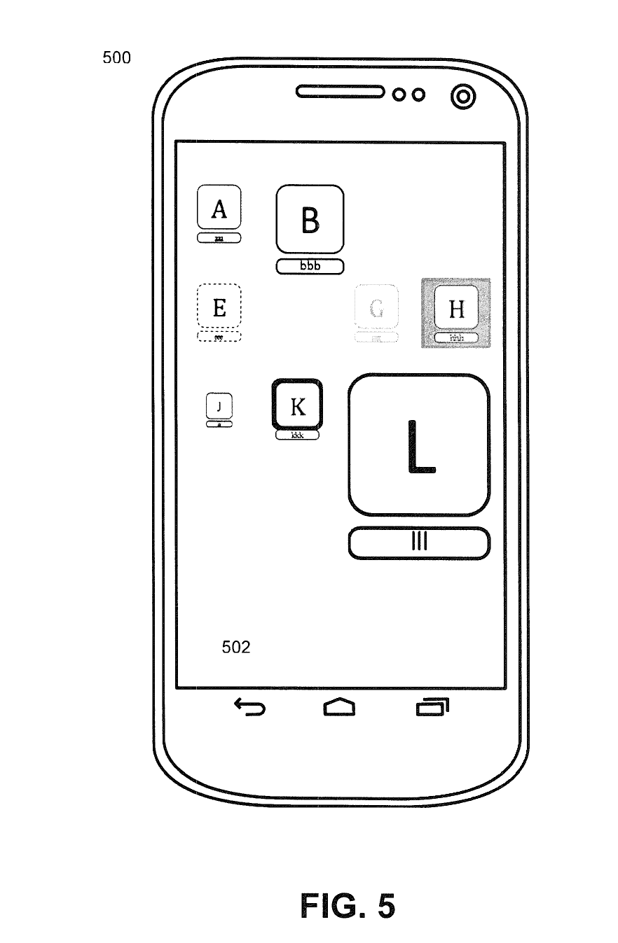

In an embodiment, the usage of an app or performance of an activity is used to determine whether and how an associated icon is displayed on a mobile device. An initial determination is made to decide whether or not an icon is displayed at all. Once an icon is displayed, its appearance or location within the display area can be enhanced to maximize or otherwise modify its visibility and attractiveness relative to the other displayed icons. FIG. 5 illustrates the enhancement of displayed icons, under an embodiment. FIG. 5 illustrates a mobile device 500 with a display screen 502, which displays a number of icons. In a standard mobile operating system and GUI, all of the icons are of generally the same size and shape, though they may have different colors or pictures to denote particular applications. Under an embodiment, the icons displayed on mobile device 500 can be visually changed to emphasize or de-emphasize an icon based on the likelihood that app will be invoked during a particular context region. Various different visual effects can be used to differentiate icons, such as size, borders, colors, transparency, glow effects, dynamic features (flashing, vibrating, etc.), and other similar effects. FIG. 5 illustrates the display of icons on the ‘home screen’ 502 of a device 500, which is typically the screen that is shown by default or upon power-up of the device. It is the screen that shows the basic functions available on the device as well as the icons for critical or user selected applications. If all available icons or graphical elements do not fit or are cannot be displayed on the home screen, one or more other screens may need to display these icons and are typically accessed by the user scrolling or flipping screens.

For the example embodiment of FIG. 5, icon A indicates the normal or default visual appearance of an icon; icon B represents an app that is more likely to be used than A, and appears larger. Likewise, icon L is for an app that very much more likely to be used and appears very large. Besides size, other visual features can be used to emphasize favored icons. For example, icon H is for a strongly likely app and is displayed with a distinct colored background to differentiate it from the normal icon A, while icon L is for a likely app, and has a bold border displayed around the icon frame.

Icons can also be de-emphasized or reduced (minimized) relative to the other icons using similar visual cues. Thus, as shown in FIG. 5, icon J is for an app that is less likely to be used, and appears smaller than normal. Other visual features can also be used for de-emphasis. For example, icon E for another less likely app features a dashed border as the icon frame, and icon G for yet another less likely app is shown as partially transparent.

In an embodiment, the system can be configured to automatically alter the display for emphasized or de-emphasized icons, and different display features can be used depending on the likeliness of use of the associated app. For example, slightly more likely/unlikely apps may have their icons change a border, while much more likely/unlikely apps may have their icons change in size. Alternatively, the system can be configured to allow the user to select or at least partially select the type of change provided to the visual features of the icons. In an embodiment a user action, such as a long press on an icon, can display to the user the reason why the app icon is shown, together with information about the app's frequency of use; e.g., a long press on the app L icon can display “This app is used an average of 25 times during the hours of 9 a.m. to 5 p.m.” while a long press on the app B icon can display “This app is used an average of 17 times while device is at this location.”

With reference to FIG. 4, as shown in act 404, minimum and maximum threshold values for application usage are defined. A minimum usage frequency value is defined for an application icon to become visible; and a maximum usage frequency value is defined for an icon to disappear. Thus, if an application is used at a frequency above the minimum usage frequency value, its icon is displayed or enhanced, act 410, and if an application is used at a frequency below the maximum usage frequency, its icon is deleted or minimized, act 412. Icons for applications that do not exceed or fall below the defined thresholds as determined in option block 406 remain unchanged, act 408. Any appropriate value (e.g., decimal value, percentage, etc.) may be used to express the threshold value. These threshold values may be preconfigured and modifiable, and the min/max values may be different from each other. For example, the threshold frequency for an app to become visible could be 0.5. In this case, if the app has historically been used with probability greater than or equal to 0.5 during the contextual region, then it is made visible on a home screen or within an application folder or other area of the user interface (if it had not previously been visible). Alternatively, it may be enhanced if it was already visible. As a further example, the maximum threshold frequency for an app to disappear could be 0.2, thus, if the app's probability of being used in a context region drops below 0.2, then the app is removed from its place on a home screen or application folder. When an app is removed, it may still be available from the device's list of all installed apps. Optionally the app may be placed into a special “infrequently used” folder for applications.

In an alternative embodiment, there may be a third threshold defined as a maximum frequency per day, as opposed to per context region (as with the other two threshold values) to determine if and when an icon would disappear and/or an app would be automatically uninstalled. For example, if this third threshold is 0.01, then if the application's probability of use historically has dropped to less than 0.01 per day, the app would be automatically uninstalled, and the icon removed. Alternatively, instead of automatically being uninstalled, the app may be added to a list for uninstalling, and the user can be prompted periodically for permission to uninstall apps that have migrated to the uninstall list. This feature may be modified depending on the type of application being modified. For example, apps that had been purchased as opposed to being provided for free may be configured to never be automatically uninstalled). An administrator (e.g., an enterprise administrator or parent of a child) may configure a particular app to never be uninstalled automatically.

In an embodiment, different sets of threshold values may be defined for different context regions. In general, the comparison of usage of an app to the threshold value or values represents the likeliness that an app will be used or not used. The threshold values can be defined relative to an application that has a defined average usage, or relative to a value that is defined to be average or baseline usage. In an embodiment, the average value can be derived or determined by usage patterns by the user as derived for usage of all apps or all apps of a certain type. Alternatively, the system can define average or baseline values based on usage by a number of users or by industry defined average usage values or patterns. In an embodiment, the user can adjust the threshold or thresholds of likeliness above which app icons will appear, change, or disappear.

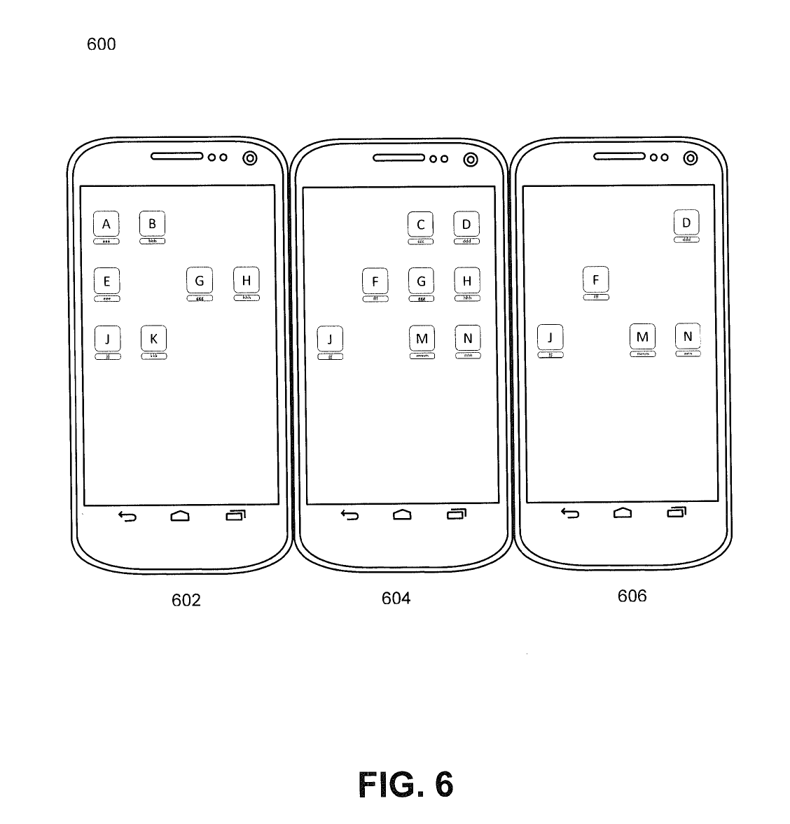

The likeliness of usage of an application may change depending on context. For example, an app may be infrequently used in general, however it may be routinely used in a specific context, such as during a particular time (e.g., only on Monday, 8 am) or when a person is in a particular place (e.g., post office). In this case, the overall usage of an app may be low, but the likelihood during a context is high. In an embodiment, the system is configured to modify the display icons based on context as well as general usage patterns. FIG. 6 illustrates an example of different icon visibility based on different context regions, under an embodiment. In the example of FIG. 6, display 602 may represent the apps that are visible during the currently active context regions. Those context regions might include a time interval of, for example, noon to 2 pm; weekday; and/or a location, such as at or near work location. In this example, icons for apps A, B, E, G, FI, J, and K are visible. Certain icons (e.g., icons A, E, and K) might be visible because their frequency of use had at one point been higher than the minimum threshold frequency for them to become visible during the defined context region (e.g., noon to 2 pm); while other icons (e.g., icons G, H, and J) might be visible because their frequency of use had at one point been higher than the minimum threshold frequency for them to become visible during the weekday context region. Yet other icons (e.g., icon B) might be visible because their frequency of use had at one point been higher than the minimum threshold frequency for them to become visible during a particular context region (e.g., at or near work).

As shown in diagram 600, the display of icons may change from that shown in display 602 based on a change of context, such as a change in time and/or place. For example, display 604 may represent the display of icons later in the day and when the user has left the work location. The overall change in context may be defined by the system in terms of known contexts. These known contexts could be derived from previous usage patterns or by objective information. For example, display 604 may represent the following context: it is 5 pm, in the 4 pm-6 pm (TOD) context region, it is still in the weekday (DOW) context region, and the user is in the commuting (geographical) context region. In the example shown in display 604, icons for apps G, H, and J are still shown as visible, because their frequency of use had at one point been higher than the minimum threshold frequency for them to become visible during the weekday context region. Likewise, icons for apps A, E, and K are no longer visible because they had qualified for being visible during the noon to 2 pm context region, but not during the 4 pm to 6 pm context region. Icons for apps C, D, and F might be visible because their frequency of use had at one point been higher than the minimum threshold frequency for them to become visible during the 4 pm-6 pm context region; and icons for apps M and N might be visible because their frequency of use had at one point been higher than the minimum threshold frequency for them to become visible during the commute context region.

Display 606 illustrates an example display of icons during yet another different context. For example, later in the week, on the weekend, the visible apps are as shown in display 606. In this example, icons for all of the apps D, F, J, M, and N might be visible because their frequency of use had at one point been higher than the minimum threshold frequency for them to become visible during the weekend context region.

The different display of icons based on context can also be enhanced by the modification of certain displayed visual features of the icons (e.g., size, borders, effects, etc.) as shown in FIG. 5. In general, the system provides the advantage of optimally displaying only the most relevant apps to the user based on the different contexts of device usage, and historical patterns defined by the user. Because the size of a home screen is limited, the user cannot put every conceivable app the user would ever want to use on the home screen since room is limited. The system overcomes this disadvantage by displaying only icons for apps that have been proven to be needed in particular context regions. This makes it relatively simple and quick for the user to scan the user's home screen and find and use the most relevant apps.

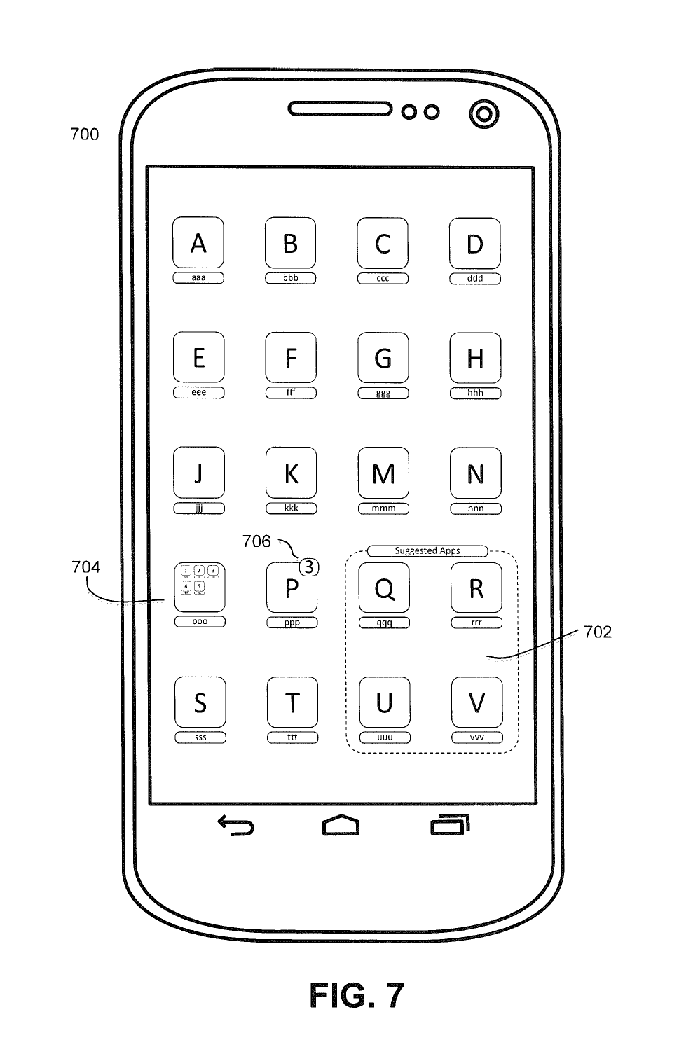

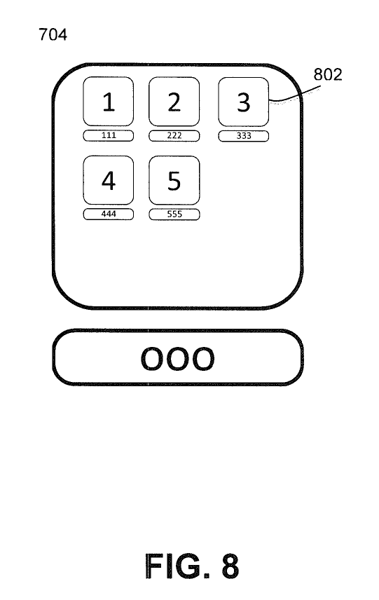

Certain display organization techniques can also be used in conjunction with the system. For example, the grouping, clustering, or hierarchical arrangement of applications in folders, subfolders or other groups can be used to modify the display of icons based on likelihood of use of the corresponding apps. FIG. 7 illustrates the modification of displayed icons using icon grouping structures, under an embodiment. In this embodiment, the visibility of apps within application folders or other grouping structures can be managed in the same automatic way as apps became visible or disappeared from the user's home screen. Once a user puts an app into a folder, this is the location from which it will automatically become visible or disappear, instead of on the home screen. As shown in FIG. 7, mobile device 700 displays a number of app/activity icons. Icon 704 is an application folder that contains one or more other icons. FIG. 8 is a detailed illustration of application folder 704 showing the display of icons 802 within this folder. An application folder contains app icons and is typically displayed in the same manner as a regular icon. It can be opened, and the app icons within can be used to launch apps just like application icons from a home screen.

In an embodiment, a displayed count or other metric can be displayed in association with each app icon. This count can indicate how close the usage of an app is getting to a maximum or minimum threshold for usage. This allows a user to know when an app's frequency is getting lower and closer to the threshold for being removed from view in an active context region. In an embodiment, the app icon can be annotated with the count value as is shown for icon P, which has a displayed count value 706, as illustrated in FIG. 7. In this example, a circle with the number 3 is overlaid showing the user that only three more days can pass before the app will be removed from this view due to lack of use.

Application usage generally requires the establishment and monitoring a usage history associated with each application. In general, when a user first obtains a device there is no app usage history on it, or when a user first begins using the system there is no app usage history available for any of the apps loaded on the mobile device. In an embodiment, there are four modes in which the system can begin operating in such a case to initialize the system and build a history. These modes are referred to as: migrated, aggregate profile, blank, and record then switch on.

For the migrated mode, the user may have an app usage history from a different device that can be used as the starting point for the system to determine which apps should be visible and which should not. For the aggregate profile, the system uses information about the user (when available) and computes a profile of app visibility across all users that match some or all of the information about the user (e.g., age, gender, occupation, locale, language, etc.) or across all users when information about the user is not known. This computed aggregate profile is used as the ‘starter set’ of which apps are visible and which are not for a user on a new device. For the blank mode, all apps start out being visible if they are already on the user's home screen (or in application folders). Apps that are not on either the home screen or in application folders, but are on the list of installed apps start out being not visible. As the user uses apps over time, certain unused apps will disappear from home screens or application folders depending on usage within specific context regions. Also, apps that do not appear currently on home screens or within application folders, but which are used frequently within specific context regions will begin to show up on home screens or within application folders as their frequency of use first exceeds the minimum frequency for visibility within a specific context region. For the mode referred to as ‘record then switch on,’ the system will initially just record application usage within specific context regions. At a time of the user's choosing or after a preconfigured initial period of time (e.g., a week), the system will switch on or engage, and begin to affect the visibility or lack of visibility of different applications during specific context regions.

In an embodiment, the system may include a preview function that allows a user to explore and see what effect different settings for frequency thresholds may have upon app visibility during specific context regions. For example, a user might want to know what the home screens and application folders would look like if the user increased the maximum frequency threshold for app disappearance in a specific context region. In this case, the preview function would display what the home screens and application folders look like currently, what they would like if the indicated changes were made, and highlight the differences.

### Application Suggestions/Substitutions

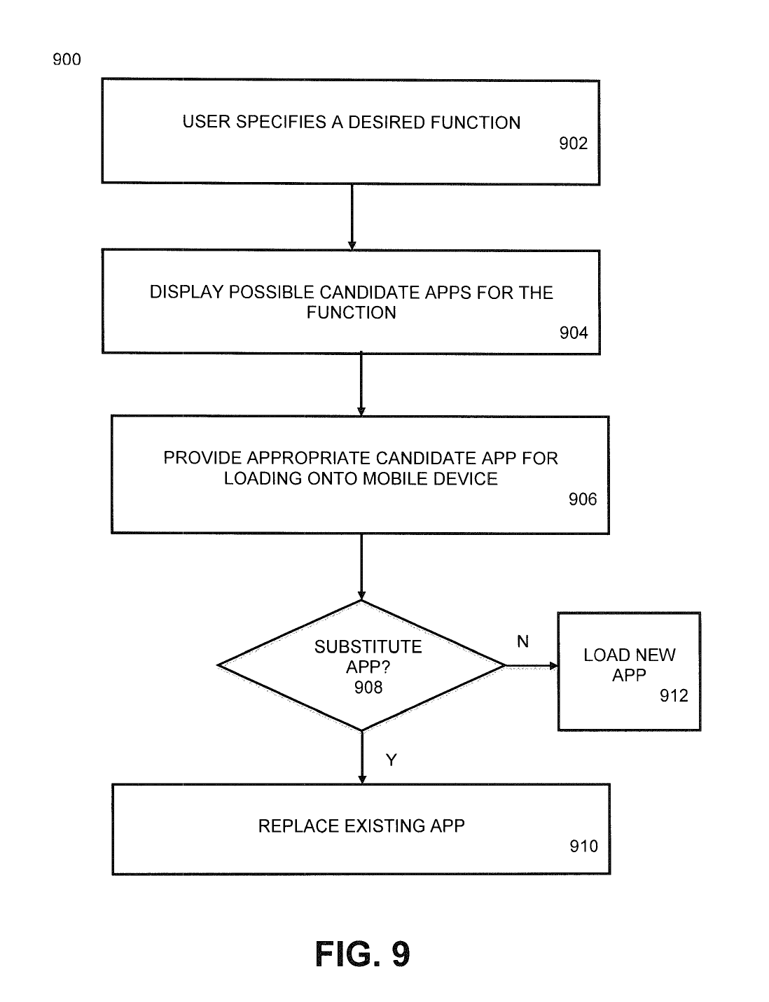

In an embodiment, the system also includes processes that suggest applications to the user or substitute existing applications for newer or other applications. For this function, the user may click on a suggested app region of the screen (or invoke a separate app suggestions application), such as shown in region 702 of FIG. 7. FIG. 9 illustrates a method of providing suggestions/substitute apps to a user, under an embodiment. As shown in diagram 900, the user knows the function that he or she wants to perform and provides this to the system, act 902. This can be done by either the user typing text describing the function or browsing from a set of functional categories (e.g., personal productivity, note-taking, etc.), or other similar method. One or more candidate suggestions for apps are then presented to the user, act 904. The presentation may consist of the name of the app and some descriptive information, and may include the app icon, although the app has not yet been installed. The criteria used for making a suggestion can include any combination of the following: matching text function description provided by the user with text descriptions in the set of app suggestion sources; popularity and/or rating of the suggested apps amongst all users, or amongst users in one or more of the user's social graphs (e.g., Facebook friends, LinkedIn associates, co-workers at the user's company, the user's family members, etc.); popular and/or rating of the suggested apps among other users that are similar to the user's usage behavior (other apps that they run with similar frequencies are similar to the apps that our user runs); and popular apps among other users that are similar to the user's personal profile or characteristics (such as the user's occupation, age, gender, language, residence location, interests as provided on social network sites or other user profile information sources, and so on). The app matching method of the suggestion/substitution process may also employ certain enterprise-based methods, such as premium app suggestions in which entities can pay for their apps to be suggested in certain categories or for certain functional descriptions, or apps suggested by the carrier or device manufacturer or the user's enterprise. Ratings services can also be used as a source of candidate apps. For example, ratings or reviews regarding specific pieces of functionality performed by apps may be available. Such ratings may be particularly fine-grained in that ratings/reviews are available for specific pieces of functionality within an app and broken out in a structured fashion. Likewise, ratings or reviews regarding the suitability of an app operating in a specific geographical area may also be available. This rating/review information can be used to identify and select possible candidate apps in the method of FIG. 9.

Once one or more candidate apps have been identified, the user can download them, or they can otherwise be automatically downloaded to the mobile device upon approval by the user, act 906. Sources of apps can include public app stores (e.g., app store 112), websites that list apps available for download, websites that review, rate, or rank apps, private enterprise app stores, or any other place from which apps can be provisioned. The user can configure the sources of apps that will be used for making suggestions, and an initial configuration can be made available when the mobile device is obtained by the user. The system can be configured to notify the user upon the identification of a candidate app and send the user a notification via OS message or other similar message about the availability of a potentially suitable app for download. Such a message could comprise an interstitial display message or a message displayed on the lock screen of the device. Alternatively, the system can automatically install an icon for the new app, which the user can view and accept if desired or delete if not desired.

As shown in FIG. 9, the candidate app may be a new application for the desired function, or it may be a substitute for an existing application, as determined in decision block 908. In the case of a substitution, where the user might be better off with a different app than one they currently have installed, a current app is replaced, act 910. If the user is in a context region that is known (based on information from app reviews or provided by a server) to be one where the user's chosen app is less than optimal and for which other substitute apps or websites could do a better job of performing one or more of the functions of the user's chosen app, then when the user attempts to open the app, the system can prompt the user with suggested substitutes, either instead of opening and running the app, or in addition to running the app (e.g., by providing a notification in the notification area of the device that there are suggested substitute apps or websites available). In this case, it may also be that a website could be a substitute for an app for performing a particular function. A similar suggestion can occur within the user's web browser, that is, if the user attempts to browse to a website and the system has alternative suggestions for substitutes, then these can be presented to the user in a similar manner.

In the case of a substitute app, the system may be configured to automatically perform the appropriate uninstall routines for the substituted app, if necessary. If, in block 908 it is determined that the candidate app is not a substitute for an existing app, it can be simply loaded as a new app onto the mobile device, act 912.

In an embodiment, the suggestion/substitution feature may be performed as a persistent query process, as opposed to a data mining process. In this case, the user might wish to perform a particular function but has been unable to find an appropriate app, and provides a description of the desired function to the device. This request acts as a persistent query against the sources of apps for suggestions. This persistent query may run on the device periodically, or on a server periodically, and inform the user when an app appears in one or more of the sources for apps that matches the user's functional description. When a match occurs, the matching app will appear in the region of the device where the user has configured to receive app suggestions.

In general, the suggestion process acts on requests from the user for particular functionality. Alternatively, the suggestion/substitution process can act as a background process that monitors the usage, context and user's profile, and provides matches based on one or more of the criteria listed above. In this alternative embodiment, the process provides suggestions of highly popular apps based on one or more of the criteria that the user may find useful, even if the user has not requested any such functionality. When suggestions are made to the user, the user is provided an option to install the app, not install the app, show other similar apps, and other similar responses. This process may also allow for users to see the popularity and ratings of the app overall or among friends or among users who use the same apps the user does.

In one embodiment, the system can monitor the actual operation of the device and suggest apps based on specific problems or usage peculiarities of the device. For example, certain applications may be suggested based on conditions such as battery usage, network usage, susceptibility to crash (e.g. frequency of ungraceful exits, UI blockage scenarios, average time between returns in a UI thread), memory usage, and other device usage characteristics. In this case, certain utilities or applications may be suggested, such as optimization, debugging, anti-virus, spam blocking, and other similar apps.

In another embodiment, the system is configured to suggest sub-applications or actions/activities related to an install app or context region of the mobile device. For example, the system may determine a particular context region for the device and automatically recommend or provide information related to the context region. For example, on a Sunday afternoon, the system can display an icon to check the score of a football game where the user's home team is playing; or on a Friday evening at 6 pm, the system can show an icon to search for nearby happy hour spots using an online service, such as Yelp.

### Icon Positioning and Appearance

As shown in FIG. 5, icons for apps can be displayed using different graphic features besides just size. In an embodiment, the icons can be visually modified depending on context regions. For example, icons can be displayed with “fuzzy edges” for context region boundaries. Such graduated or dynamic display modification allows the user to see how his or her context affects the display of the icons. For instance, for a time interval-based context region of noon to 2 pm, a fuzzy edge for the context region boundary would allow apps marked as being visible in the noon to 2 pm context region to start appearing a certain amount of time in advance of the beginning of the context region, e.g., 10 minutes before noon. Similarly, app visibility could be relaxed at the other boundary of a time-interval-based context region of noon to 2 pm; while apps marked as being visible during this context region, but not during the succeeding context region of 2 pm-4 pm, could remain visible for a configurable amount of time past the context region boundary (e.g., for another 10 minutes until 2:10 pm).

For geographic-based context regions, the mechanism of displaying a fuzzy edge for a context region can be based on a distance the user is currently away from a geographic-based context region, and optionally the user's direction and/or speed of motion. For example, apps that are marked to be visible in the geographic-based region for the user's home can begin to be visible as soon as the user is within a certain distance (e.g. two miles) of the context region, or within a certain time (e.g., two minutes) of arriving at the context region at the user's current rate and direction of motion. Similar fuzzy boundaries can be used for when the user is leaving a geographic-based context region.

It should be understood that there can be many different definitions for time-interval-based context regions, and that they can be contiguous intervals of same or different lengths. Similarly there could be both fine-grained and large-grained time-interval-based context regions active at the same time (e.g., ones for every two hours, ones for every fifteen minutes, and ones for eight hour periods).

In an embodiment, one or more additional types of context regions can be defined by the occurrence of a discrete event occurring on or perceived/sensed by the mobile device. These occurrences are typically triggered by a function of the mobile device itself, such as the receipt of a call, text, emergency signal, and so on. Such a triggering event could also be defined by the user, such as entering a specific geographic location, departing a cell coverage location, exceeding a speed limit, and so on. Other trigger-events defining a context region can include receipt of specific communications (e.g., voice call, text message, email, etc.) or from a particular sender or class of sender (e.g., co-worker, student, etc.), and so on. This type of context region is referred to as a ‘triggered context region’ and begins instantaneously when the discrete event occurs. The time duration of the context region can be configured to last for a fixed amount of time, or to have a fuzzy set membership function which declines over time, e.g., after 10 minutes this context region's set membership function has declined by half. The effective thresholds for app visibility and disappearance are modified by the value of a fuzzy set membership function for such a region. For example, an app that is sometimes used after a given discrete event might become visible immediately and remain visible for five minutes, while an app that is almost always used after a given discrete event might become visible immediately and remain visible for 15 minutes. Other types of discrete events that can define the start of a discrete-event context region can include the use of a different application, the sending of a message, the use of a particular device feature or sensor or means of communication, or can be user or application defined discrete events.

In an embodiment, the system is configured to modify a location of an icon as part of the modification of displaying an icon. Most icons for native apps are placed in default locations of a home screen, while apps added by the user are normally placed by default in order of their installation. A typical default organization for a mobile phone screen is to start displaying icons at the upper left corner and proceed horizontally in rows until the home page is filled, and then start additional screens as required. In general, one or more areas of the screen may be more desirable or attention-getting than other regions of the screen, if all of the icons are displayed in the same size and relative appearance. For example, the center of the screen or the upper left corner may be more desirable than other areas in which to place frequently used app icons. In this case, the system can be configured to automatically and dynamically move icons to system or user defined locations on the screen based on their usage in particular context regions.

In general, the visual prominence of an app icon is based on the predicted likelihood that a user is going to use it, and more likely used apps are given a visual emphasis that includes size, boldness to text, opacity, position with the screen. Any one of these display properties may change as the context region changes. For example, 9 am on the wall to work, the Twitter icon is at the top of the screen with a big icon, whereas at 7 pm on a Friday night, the Yelp icon is in that location.

In certain cases, the movement of icons may present a problem or may be undesirable to a user, such as due to the fact that dynamic display of apps runs against muscle memory. For example, a user may automatically remember that a particular app icon is usually on the lower right of the home screen, and would be annoyed if it moved. In this case, the system can be configured to group recommended or other apps into sets, where that set is always displayed together based on context region (e.g., work, home, weekend, travel, at a football game). The sets may have names so, to a user, the system works as a set of dynamic folders, where the apps in each folder are determined by the system. The physical layout of the apps does not change, and the system determines based on context which folder to show at a given time. The folders can also be named based on context, or they can be named or renamed by the user.

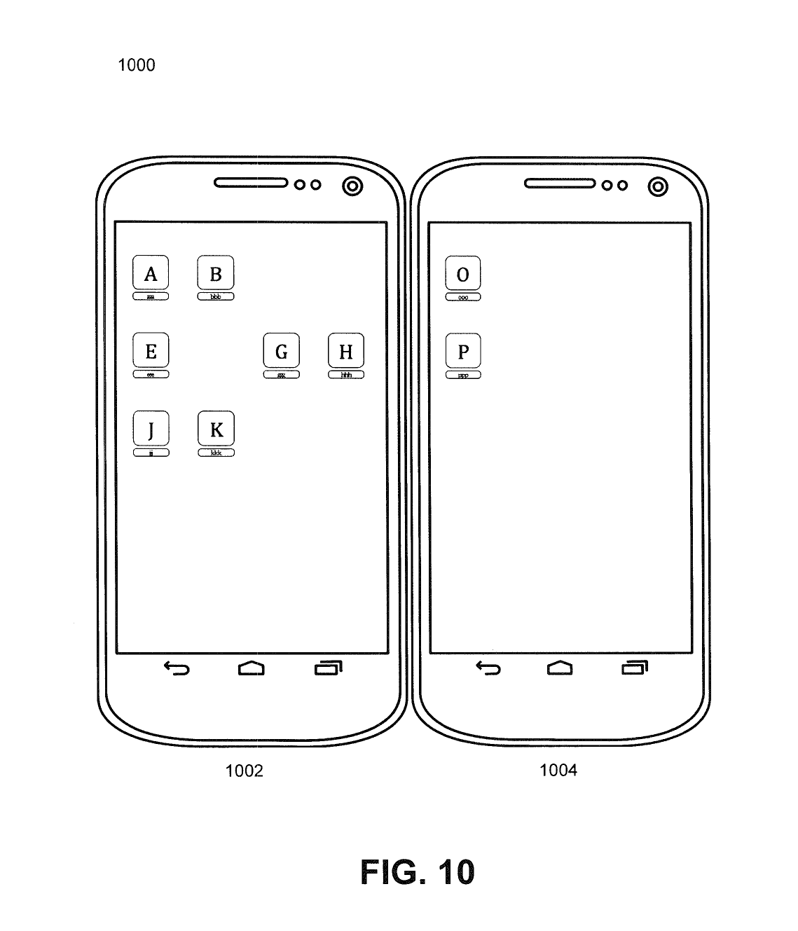

Also with regard to dynamically movable icons can be an issue related to desired position conflict. In this case, two or more icons may have the same preferred location, and the system is configured to resolve this potential conflict. FIG. 10 illustrates a potential desired position conflict that is resolved by an application management process, under an embodiment. As shown in diagram 1000 icons O, P in display 1004 have preferred locations at top left, and at top left down one row. For display 1002, icon A also has the desired position in the top left corner, and thus there is a conflict if icons A and O are to contextually appear at same time. Likewise for icons E and P in these two display situations 1002 and 1004.

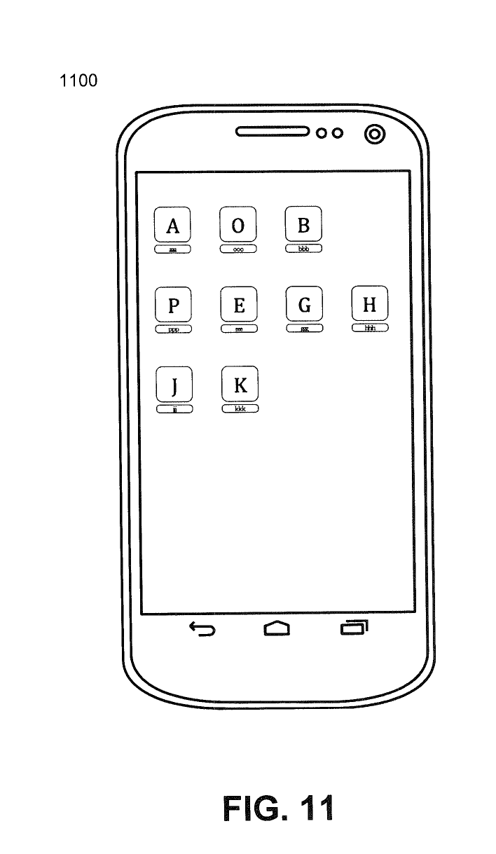

In one embodiment, the higher priority app in the display position conflict gets desired spot, the next priority app is placed nearby, and adjacent apps are moved or position-adjusted accordingly. Priority is based on frequency of use or higher likelihood of use. Thus, if app A has higher priority than app O, the icon for app A gets the desired spot, the icon for app O placed adjacent to A, and the icon for app B is moved/position-adjusted. Likewise if app P has higher priority than app E, the icon for app P gets the desired spot, and the icon for app E is placed adjacent to it. This resulting display arrangement is illustrated diagram 1100 of FIG. 11.

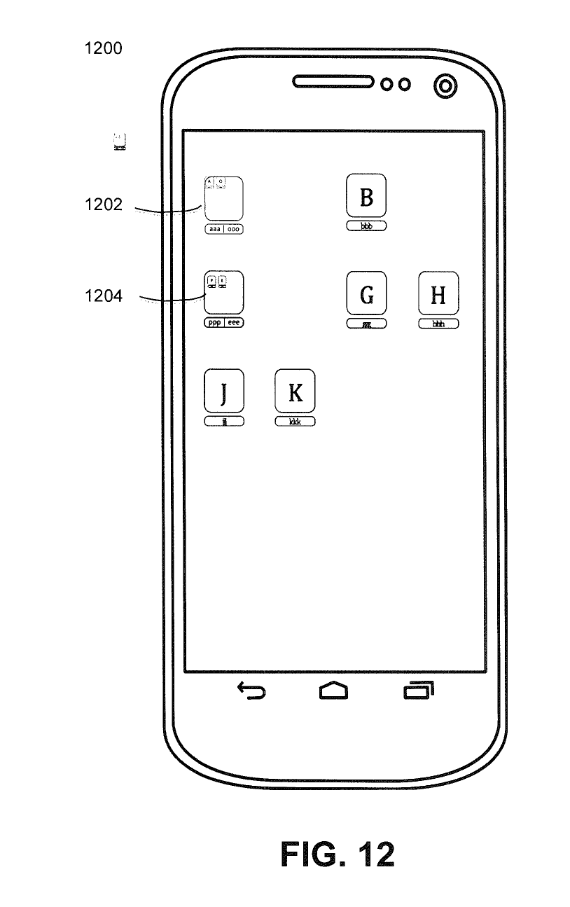

In an alternative embodiment, folders are used to resolve the desired position conflict. In this embodiment, in the case of a conflict, a new (dynamic) folder is created. FIG. 12 illustrates the use of folders to resolve the desired position conflict, under an embodiment. As shown in diagram 1200, icons for conflicting apps A and O both appear within a new folder 1202, and icons for conflicting apps P and E appear within a new folder 1204. In this manner, icons for any apps that had a conflict for a particular position appear (within a folder) at the same desired position.

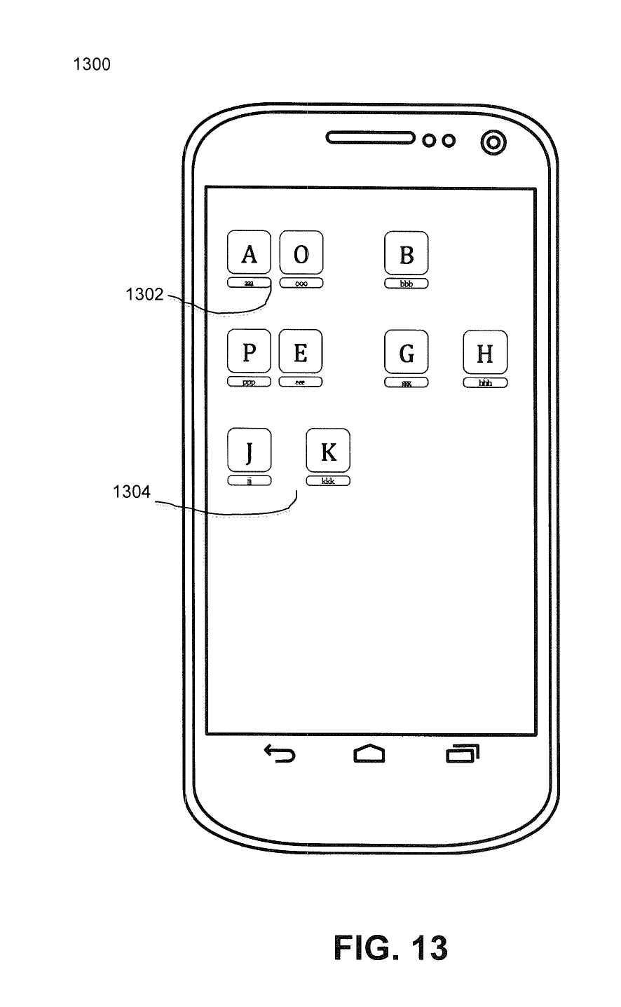

In yet another embodiment, the desired position conflict is resolved by altering a distance between the conflicting icons. FIG. 13 illustrates the use of altered spacing to resolve an icon display conflict, under an embodiment. As shown in diagram 1300, a closer than normal spacing 1302 is used to allow placing apps A and O in as close to the desired spot as possible, and similarly for apps P and E. The revised spacing may be set by the system or it may be user defined, and is typically a percentage of a default or normal spacing 1304 between the icons, such as 50% the normal spacing. In some cases, the spacing may be reduced to zero so that the two conflicting icons are be displayed as connected along a common border, or even with some degree of overlap.

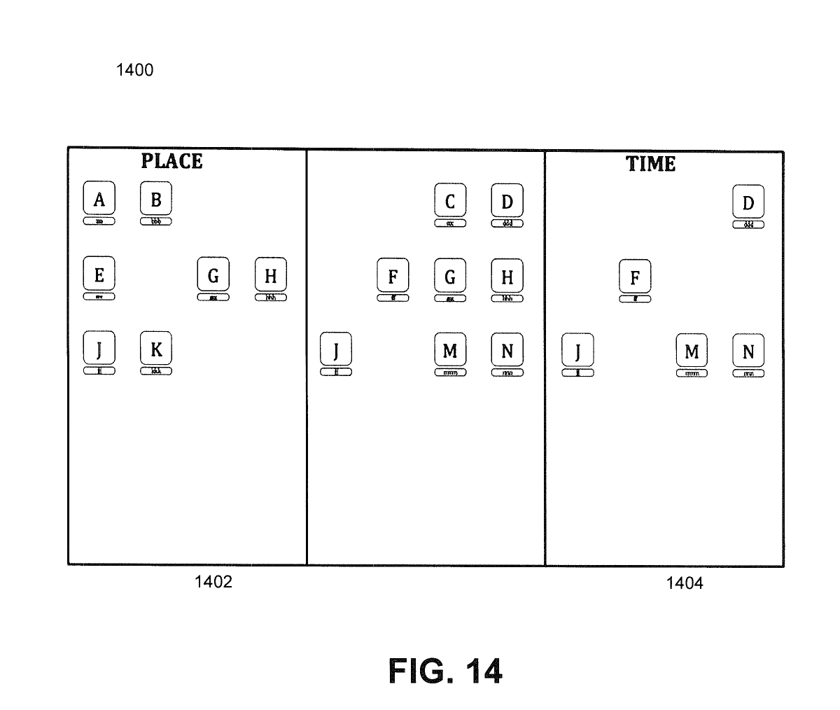

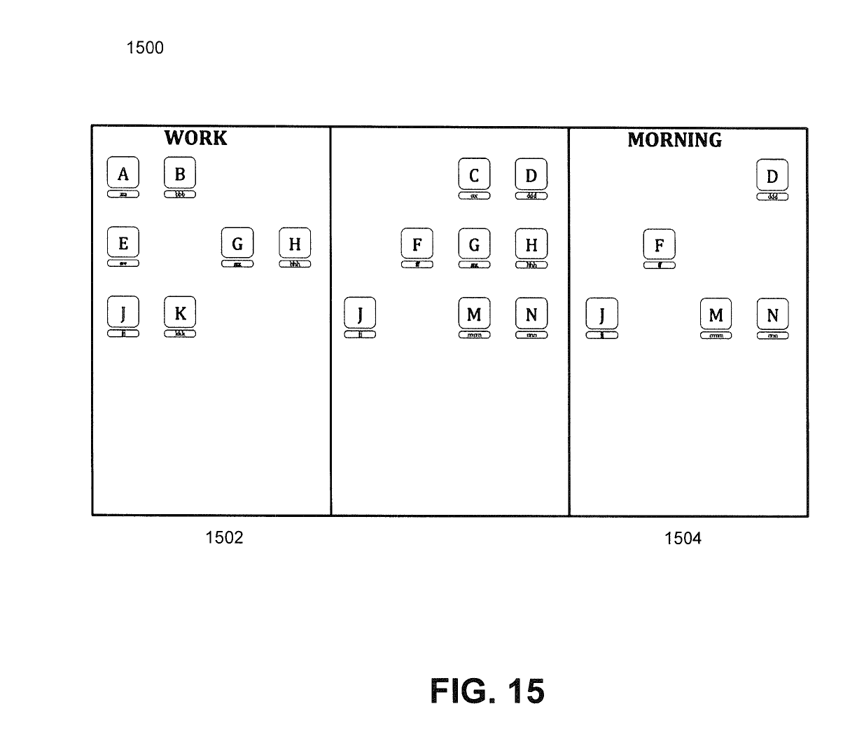

In a typical mobile GUI environment, the home screen is a single screen that shows all of the available icons. In certain cases, however, the home screen may be implemented across more than one (multiple) screens. In an embodiment, the icon and application management process is configured to show icons across multiple screens and position the icons within particular display panels (screens), regions or folders. For this embodiment, a typical home screen may consist of several panels, which are viewed one at a time by scrolling left to right. FIG. 14 illustrates three possible home screen layouts implementing an icon management process, under an embodiment. Screen 1402 may represent the display of icons associated with the context of place. Thus, the user has designated the leftmost panel to hold the apps that contextually appear based on place (e.g., home or work). The user has also designated the rightmost panel 1404 to hold the apps that contextually appear based on time (e.g., morning versus evening). During the morning, while the user is at work, the home screen panels appear as shown in FIG. 15, which has the two relevant display panels 1502 and 1504 respectively labeled ‘Work’ and ‘Morning’ as the corresponding specific instances of the ‘Place’ and ‘Time’ contexts. App icons appear in screen 1502 because the user is at work, and app icons that appear because it is morning appear in the right most panel 1504. In a similar fashion, the user may designate a region of a home screen panel, or a particular folder, as a contextual location for appearance of any dynamic app icon, or ones that appear based on time or ones that appear based on place, or any combination thereof. In one embodiment, icons may be replicated if they are displayed on two different screens.

Any of the above embodiments may be used alone or together with one another in any combination. The one or more implementations encompassed within this specification may also include embodiments that are only partially mentioned or alluded to or are not mentioned or alluded to at all. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

In addition, one will appreciate that in the description above and throughout, numerous specific details are set forth in order to provide a thorough understanding of the present invention. It will be evident, however, to one of ordinary skill in the art, that the present invention may be practiced without these specific details. In other instances, well-known structures and devices are shown in block diagram form to facilitate explanation.

Unless stated otherwise, a specific order of performing acts, steps, or process functions is not constrained to that implied by an illustrated or described order in the Figures, Description, or Claims. Process steps and claim elements may be performed in any order unless a specific dependency on a stated order is explicitly provided. Moreover, certain acts and elements may comprise portions of a process step or they may comprise a combination of process steps. Such described acts are not necessarily unitary or exclusively performed as single process steps.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for managing applications and displaying application icons on a mobile device, the method comprising:
monitoring usage of the applications by a user of the mobile device;
altering a display of an icon representing an application based on the usage of the application and a context of the mobile device; and
suggesting installation of one or more substitute or additional applications based on the usage of the application.

2. The method of claim 1 wherein the context of the mobile device is selected from the group consisting of: a location of the device, a time of the usage of an application, a frequency of usage of the application, and an activity associated with the usage of the application.

3. The method of claim 2 wherein the icon comprises a graphical element displayed through a graphical user interface on the visual display component of the mobile device, and wherein the icon represents at least one of: an activity, an application program, a sub-application, a task, data content, and a parameterized activity.

4. The method of claim 2 further comprising:
defining a baseline measure for the usage of the application;
defining an average appearance of an icon representing the application;
defining a threshold value indicating a minimum amount of variation in usage to trigger an alteration in the appearance of the icon;
determining a likeliness that the application will be used to a greater or lesser extent relative to the baseline measure; and
altering the appearance of the icon from the average appearance if the likeliness exceeds the threshold value.

5. The method of claim 4 wherein the baseline measure is derived from at least one of an initialization process or an average historical usage of the application by the user or other users.

6. The method of claim 5 wherein the initialization process comprises one of: migrating use history for the application by one or more other devices used by the user, deriving a profile of the application visibility based on profile information for the user and other users of the application, assigning a default initial usage measure, and measuring usage for a defined initial period of time.

7. The method of claim 4 wherein the threshold value comprises a minimum frequency value for the icon to be visible on the display, and a maximum frequency value for the icon to be non-visible on the display.

8. The method of claim 7 wherein minimum frequency value and maximum frequency value are one of: an identical value or different values.

9. The method of claim 4 wherein altering the appearance of the icon comprises at least one of: changing a size of the icon from an average size, changing a location of the icon on the display from an average or default location, changing a border element of the icon, changing a shape of the icon, changing a color of the icon, changing the opacity of the icon, and causing the icon to flash.

10. The method of claim 9 wherein the appearance of the icon is enhanced or maximized to be more prominent on the display relative to the average appearance if the likelihood of use exceeds the threshold.

11. The method of claim 9 wherein the appearance of the icon is de-emphasized or minimized to become less prominent on the display relative to the average appearance if the likelihood of use is less than the threshold.

12. The method of claim 9 further comprising grouping the altered icon with other altered icons using a grouping structure defined by the graphical user interface.

13. The method of claim 9 further comprising displaying a number with the icon to indicate a count measuring the usage of the application associated with the icon.

14. The method of claim 1 wherein suggesting installation of one or more substitute or additional applications is based at least in part on usage of the substitute or additional application by one or more other users in a context similar to the context of the mobile device.

15. The method of claim 14 further comprising:
automatically notifying the user of the availability of the substitute or additional application,
receiving a request from the user to install or not install the substitute or additional application onto the device; and
automatically installing the substitute or additional application onto the device upon receipt of a request to install from the user.

16. The method of claim 15 further comprising performing a persistent query on a periodic basis to identify the substitute or additional applications by querying databases of third party application providers.

17. The method of claim 15 further comprising analyzing data associated with at least one of the user, the one or more other users, present installed applications, and the context to identify the substitute or additional applications through one or more data mining techniques.

18. The method of claim 15 further comprising grouping icons for each of the substitute or additional applications together using a grouping structure defined by the graphical user interface.

19. A method of managing applications on a mobile device, comprising
monitoring usage of an application by a user of the mobile device;
monitoring usage of at least one other application related to the application by other users; and
suggesting usage of the at least one other application instead of or in addition to the application by the user of the mobile device.

20. The method of claim 19 further comprising:
automatically notifying the user of the availability of the at least one other application,
receiving a request from the user to install or not install the at least one other application onto the device; and
automatically installing the at least one other application onto the device upon receipt of a request to install from the user.

21. The method of claim 20 further comprising performing a persistent query on a periodic basis to identify the at least one other application by querying databases of third party application providers.

22. The method of claim 20 further comprising analyzing data associated with at least one of the user, the other users, present installed applications, and a context of the mobile device to identify the at least one other application through one or more data mining techniques.

23. The method of claim 20 further comprising grouping icons for the at least one other application together with other suggested application icons using a grouping structure defined by the graphical user interface.

24. The method of claim 20 wherein the context of the mobile device is selected from the group consisting of: a location of the device, a time of the usage of an application, a frequency of usage of the application, and an activity associated with the usage of the application.

25. The method of claim 20 wherein the at least one other application is provided by an application store maintained by server coupled to the mobile device over a network.
